(19) United States
(12) Patent Application Publication
(10) Pub. No.: US 2010/0010874 A1
(43) Pub. Date: Jan. 14, 2010

(54) Systems and methods of evaluating and extending a loan secured by an invention idea of a borrower

(76) Inventors: Carissa Tener Howard, Rendondo Beach, CA (US); Charles Tucker Rosen, Oil City, PA (US); Kevin Patrick Howard, Rendondo Beach, CA (US)

Correspondence Address: Carissa Tener Howard;#A, 2213 Dufour St., Redondo Beach, CA, 90278, US

(21) Appl. No.: 12/500,933

(22) Filed: Jul. 10, 2009

Related U.S. Application Data
(60) Provisional application No. 61/079,785, filed on Jul. 10, 2008.

(51) Int. Cl. G06Q 40/00; G06Q 10/00; G06Q 50/00

(52) U.S. Cl. 705/10; 705/38

(57) ABSTRACT

Systems including computer readable programs and methods of evaluating loan applications and extending loans to borrowers secured by the borrower's undeveloped, but potentially patentable and/or marketable invention idea, includes evaluating an invention idea invented by a borrower, assigning a value to the invention idea and determining an amount of money to extended to the borrower, and obtaining one or more of an ownership interest in the invention idea or a security interest in the invention idea as collateral. Also disclosed are criteria for conducting an analysis of the invention idea to determine one or more terms of a loan to be extended to the borrower.

### CROSS-REFERENCE TO RELATED APPLICATIONS

This application claims priority to a provisional application having Ser. No. 61/079,785, filed Jul. 10, 2008, the contents of which are hereby incorporated by reference in their entirety.

### BACKGROUND OF THE INVENTION

The present invention generally relates to a method of evaluating and extending loan applications. Specifically, the present invention relates to a method of evaluating and extending a loan application where a financial institution lends money based on a borrower's undeveloped, but potentially patentable and/or marketable invention idea.

Financial institutions, such as banks, venture capital firms, private equity firms, and other investment companies are always looking to provide new lending products to customers. Financial institutions frequently lend money to borrowers in the form of a mortgage, where a piece of real or commercial property is used by the borrower to secure the loan. In today's mortgage crisis, lenders are interested in generating new types of loans. In the present invention, intellectual property, as compared to real property, may be used to secure loans.

Financial institutions have secured loans in existing patents and patent applications. However, financial institutions have not been able to evaluate and thus lend money against new ideas, inventions, and disclosures before now. This is because traditional intellectual property has been difficult to value, and there is a wide array of potential uses for intellectual property. Moreover, recent developments in intellectual property laws in the United States have made evaluating the value of intellectual property very difficult.

Venture capitalist firms may have some experience in evaluating existing businesses and business plans, which may include patents and patent applications, but are generally not involved at these earlier stages of the process, such as at the time of the invention disclosure, as contemplated by the present invention. Therefore, venture capitalist firms do not have the ability to intake and evaluate invention ideas in order to lend money to inventors.

Many individual inventors do not have the financial means necessary to develop their ideas into patents or marketable/tangible products or a going business concern. Developing the invention may involve building a prototype, drafting and filing a patent application, performing market research on the invention, developing a business model, starting a business, identifying potential investors, identifying potential users of the invention, manufacturing the invention, licensing the invention, and the like. The present invention provides a means in which inventors may borrow seed money necessary to develop their inventions. The present invention also contemplates that the borrowed money does not necessarily have to be spent on developing the invention.

Because of the problems encountered by financial institutions in valuing intellectual property, and the problems of inventors in monetizing inventions, there is a need in the art for systems and methods of properly evaluating invention ideas and accurately projecting value for intellectual property covering the invention ideas. Such a need lends itself to extending loans based on the undeveloped invention ideas, once value is accurately assessed. Accordingly, the present invention provides systems and methods for financial institutions to extend a novel type of loan product to its customers based on the potential borrower's undeveloped invention idea.

### SUMMARY OF THE INVENTION

The present invention discloses a method of evaluating and extending loan applications, where a financial institution lends money based on the borrower's undeveloped, but potentially patentable and/or marketable invention idea. Also disclosed are systems and methods for objectively evaluating an invention idea.

According to one embodiment of the present invention, a method of securing a loan to be extended to a borrower comprises evaluating an invention idea invented by a borrower, the evaluating an invention idea further comprising determining a market potential for the invention idea and analyzing a likelihood of obtaining intellectual property protection covering the invention idea in at least one jurisdiction. The method also includes assigning at least one value to the invention idea and determining one or more terms of a loan to be extended to the borrower, and obtaining, from the borrower, one or more of an ownership interest in the invention idea or a security interest in the invention idea as collateral for a loan.

According to another embodiment of the present invention, a method of extending a loan to a borrower comprises soliciting a description of an invention idea from the borrower and conducting an analysis of the invention idea. The analysis includes an identification of an invention field, a study of market potential for at least one product covered by the invention idea, and a patentability study of the invention idea in at least one jurisdiction. The method further includes determining one or more terms of a loan to be extended to the borrower based at least in part upon converting a result of the analysis of the invention idea into at least one value of the invention idea, securing the invention idea as collateral for the loan, and closing the loan by extending the amount of money to the borrower.

According to yet another embodiment of the present invention, a system for facilitating the extension of a loan based on an invention idea comprises a computer readable program, embodied on at least one module in a computer hardware environment, configured to accept a description of an invention idea from a borrower. The system also comprises a computer readable program, embodied on at least one module in a computer hardware environment, configured to conduct an analysis of the invention idea, the analysis including an identification of an invention field, a study of market potential for at least one product covered by the invention idea, and a patentability study of the invention idea in at least one jurisdiction. The system further includes a computer readable program, embodied on at least one module in a computer hardware environment, configured to convert a result of the analysis of the invention idea into a value of the invention idea, the value of the invention idea determined by comparing a result of the analysis to pre-selected criteria that comprise one or more of a baseline determination of profitability, a baseline determination of percentage market share, a baseline determination of cost for making the invention, a numerical value based on the numbers of patents in the field of the invention, a numerical value ranking the invention to the closest piece of prior art, and number of competitors, wherein the program assigns a first value based on a number of patents and printed publications in an invention field, identification of a closest piece of prior art, and a comparison of the invention idea to the closest piece of prior art, and assigns a second value based on a number of elements lacking in the closest piece of prior art when compared to the invention idea, and sums the first value and the second value together to generate a score. The system also includes a computer readable program, embodied on at least one module in a computer hardware environment, configured to determine one or more terms of a loan to be extended to the borrower based upon the value of the invention idea.

In an additional embodiment of the present invention, a method of offering a loan to a borrower comprises offering a loan through a financial institution, wherein the loan is secured by the borrower by disclosing to the financial institution an invention idea of the borrower. The method also includes obtaining from a borrower by the financial institution one or more of an ownership interest in the invention or a security interest in the invention as consideration for the loan, and providing by the financial institution money for the loan to the borrower.

For any of the disclosed methods, there are several features that may be further incorporated. For example, the financial institution, such as a bank, credit union, investment firm, or venture capitalist firm, may obtain a security interest in the invention or an ownership interest in the invention. The financial institution may evaluate the invention, for free or for a fee, such as by conducting one or more of a prior art search, market research on the invention, building a model of the invention, and researching the invention's competition. The financial institution, itself, or with one or more suitable vendors, may draft, file, and prosecute one or more patent applications associated with the invention.

The terms of the loan may include forgiveness for at least part of the loan if the invention is commercially successful. The amount of the loan may be used by the borrower to develop the invention, to bring at least one product covered by the invention idea to market, or to purchase real property or other property unrelated to the invention idea. The bank and the borrower may enter into a confidentiality agreement before the borrower discloses the invention to the bank.

Another embodiment of the present invention is a method of offering a loan to a borrower comprising offering a loan through a financial institution, wherein the loan is for at least the development of an invention. The method also includes obtaining from a borrower one or more of an ownership interest in the invention or a security interest in the invention as consideration for one or more of the loan and services related to the invention, and providing by the financial institution money for the loan. The services related to the invention may include one or more of conducting a prior art search, drafting, filing, and prosecuting one or more patent applications.

Another embodiment of the present invention is a method of offering a loan to a borrower comprising obtaining a loan application from a borrower including a description of an invention, and evaluating the loan application, wherein the evaluating comprises performing one of more of a prior art search on the invention, market research on the invention, building a model of the invention, and researching the invention's competition. The method further includes offering a loan through a financial institution based on the results of the evaluation.

Other aspects may include comparing the results of the evaluation to pre-selected risk criteria and making a recommendation to a financial institution on the loan application. The evaluation may be performed by one or more of a prior art search company, a patent attorney, a market research group, or a venture capitalist firm. The pre-selected criteria may include one or more of a baseline of profitability, baseline of percentage market share, a baseline cost for making the invention, a numerical value based on the numbers of patents in the field of the invention, a numerical value ranking the invention to the closest piece of prior art, and number of competitors.

Another embodiment of the present invention is a mathematical model for evaluating an invention comprising identifying the invention field, performing a prior art search, and assigning a first value based on the number of patents and printed publications in the invention field. The mathematical model also includes identifying the closest piece of prior art, comparing the invention to the closest piece of prior art, and assigning a second value based on the number of elements lacking in the closest piece of prior art as compared to the invention. The mathematical model further includes adding the all the values together to generate a score. Further features may include identifying the number of potential users of the invention and assigning a third value based on those potential users.

Yet another embodiment of the present invention is a computer software program for facilitating the offering of a loan based on an invention. The program comprises a computer implemented application connected to a spreadsheet application, the computer implemented application having a plurality of data input screens configured and arranged for input of data including loan origination data, demographic data, and data relating to one or more inventions, the computer application also including information screens for displaying the results of an evaluation of the invention, wherein the evaluation is based on one or more of a prior art search on the invention, market research on the invention, building a model of the invention, and researching the invention's competition. The computer application also includes means for comparing the evaluation to pre-selected risk criteria.

Further components include means for evaluating the invention, means for generating an approval of the borrower's ability to repay the loan based upon the evaluation, means for generating loan documentation based upon the evaluation, means for transmitting the loan documentation to the borrower, and means for generating a credit score.

Other features and advantages of the present invention will become more apparent from the following description of the embodiments, taken together with the accompanying drawings, which illustrate, by way of example, the principles of the invention.

### BRIEF DESCRIPTION OF THE SEVERAL VIEWS OF THE DRAWINGS

FIG. 1 is a flowchart showing steps of a method according to the present invention.

### DETAILED DESCRIPTION OF THE INVENTION

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

As used throughout this disclosure, the singular forms “a,” “an,” and “the” include plural reference unless the context clearly dictates otherwise. All technical and scientific terms used herein have the same meanings as commonly understood by one of ordinary skill in the art to which this invention belongs, excepting terms, phrases, and other language defined herein. Before the present systems and methods are described, it is to be understood that this invention is not limited to the particular systems and methodologies or protocols described, as these may vary. It is also to be understood that the terminology used in the description is for the purpose of describing the particular versions or embodiments only, and is not intended to limit the scope of the present invention which will be limited only by the appended claims. For simplicity, each reference referred to herein shall be deemed expressly incorporated by reference in its entirety as if fully set forth herein.

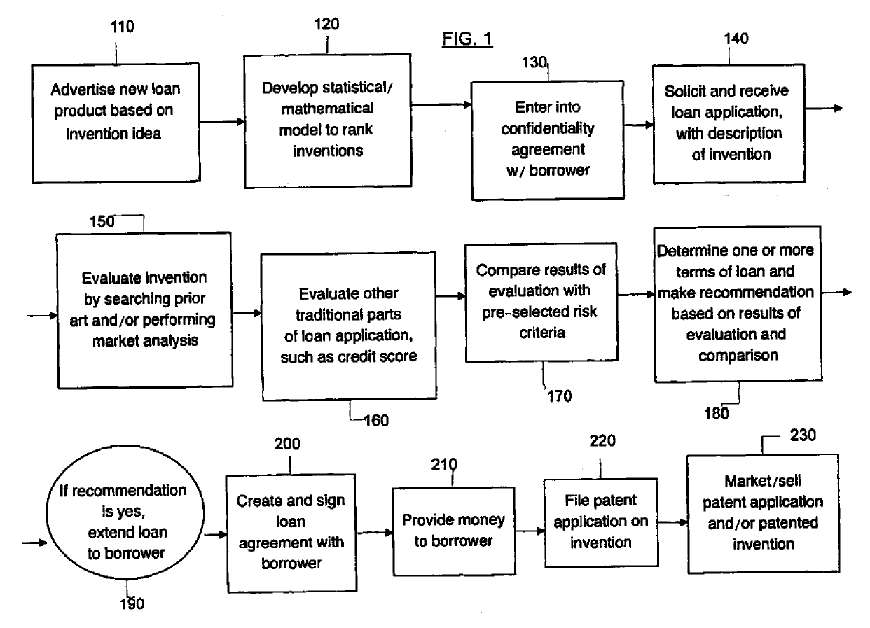

FIG. 1 is a flowchart showing steps of a method of evaluating an application for a loan and extending a loan to a borrower according to several embodiments of the present invention. A financial institution, which may include but is not limited to a bank, a credit union, a venture capital firm, and a private equity firm, or any other entity engaged at least partially in the business of lending money or extending loans to companies or individuals, advertises a loan product to be at least partially secured by an invention idea in step 110. This may also include soliciting invention ideas from specific companies or individuals. The financial institution develops a mathematical model to rank, score, or assign value to an invention idea as in step 120, thereby converting information provided by the borrower regarding the invention idea into tangible form so that a physical loan product can be customized and extended to the borrower. This may involve identification and modification of pre-selected criteria as discussed herein, based on the issues such as field of the invention, market potential, likelihood of patentability, etc. The financial institution then may enter into a confidentiality agreement with a potential borrower in step 130 who is interested in becoming a customer of the financial institution and its loan product as advertised or solicited in step 110. The confidentiality agreement with the borrower in step 130 may extend to the financial institution extending the loan, and may also extend to any entity with whom the financial institution outsources to perform services contemplated herein, such as for example a prior art search firm.

The potential borrower then discloses the invention idea to the financial institution in step 140 by filling out a loan application and providing a detailed description of the invention idea. The borrower provides as much detail as possible about the invention idea, including the extent of the development of the invention idea such as his or her reduction to practice, if any, and products that may cover the invention idea and thoughts about market potential. The more detail the potential borrower provides, the more information the financial institution has to evaluate the invention idea and conduct an analysis of the invention idea under steps 150, 170, and 180. At step 140, the potential borrower may orally disclose the invention idea to a loan officer, may fill in the information on a suitable web-based application using the computer readable software described herein, or combinations thereof.

After the invention idea has been disclosed, the financial institution then collects the information provided and conducts an analysis of the invention idea under step 150. This evaluation is conducted by analyzing several factors, including but not limited to patentability, market potential for products covering the invention idea, and projected revenue from licensing or enforcement of intellectual property covering the invention idea. One example of an analysis conducted under step 150 is a extensive search of prior art and comparing the prior art to the invention idea as discussed herein. Another example is a market analysis of existing products and market penetration of same for similar products to those covered by the invention idea. The evaluation or analysis conducted under step 150 may be performed by the financial institution itself, or outsourced to patent professionals such as attorneys, agents, or prior art search professionals.

In step 160, the financial institution may evaluate more traditional parts of the borrower's loan application. For example, the financial institution may obtain the borrower's credit score, and include the credit score among the factors considered when evaluating the invention idea and the terms of the loan to extend to the borrower.

In step 170, the financial institution compares the results of the evaluation of the invention idea with pre-selected criteria as further described herein. Examples of pre-selected criteria may include, but are not limited to, a baseline determination of profitability, a baseline determination of percentage market share, a baseline determination of cost for making the invention, a numerical value based on the numbers of patents in the field of the invention, a numerical value ranking the invention to the closest piece of prior art, and number of competitors. It is to be understood that many different aspects of the invention idea may be evaluated as disclosed herein, and that a financial institution may customize the evaluation performed and the pre-selected criteria used depending on issues such as the invention idea itself, the level of detail provided by the borrower, and the field of the invention idea.

The financial institution then makes a recommendation regarding specific attributes of the loan based on the outcome of the mathematical model used to evaluate the invention idea, in step 180. The recommendation may include issues such as the amount of money to be loaned, the length of repayment of the loan, the interest rate, the form in which the financial institution will secure the invention idea as collateral (including any percentage of ownership), and any other factors attendant to extending a loan. If the recommendation is a positive one for the financial institution, the loan will be extended to the borrower in step 190.

The financial institution then generates the appropriate loan documentation and executes the loan agreement with the borrower in step 200. Loan documentation as contemplated by the present invention may include obtaining a security or ownership interest in the invention idea, or in any intellectual property developed to cover to the invention idea, or both. The financial institution may record the security interest or ownership interest that it has received from the borrower with all appropriate recording offices, such as for the example the United States Patent & Trademark Office.

The financial institution then provides money to the borrower in step 210. The financial institution may obtain the right to pursue such intellectual property protection for products covering the invention idea as part of loan documentation in step 200, and may further file one or more applications for patent and trademark protection under step 220. In further later stages of the process, the financial institution may work with the borrower, or with a third party, to develop the invention idea and market or sell products covered by the invention idea in step 230. Additionally, the financial institution may also market or sell the intellectual property rights filed for or obtained that cover products covered by the invention idea.

The present invention contemplates that a mathematical model used to evaluate an invention idea may take many forms. The following is one example of a mathematical model that could be used to evaluate an invention disclosure. The highest score that an invention could receive is 100 points, while the lowest is 1. The higher the score, the lower the risk to the financial institution. There are several individual scores that may be scaled and added together to make the total score. One individual score may be based on how crowded the prior art of the field of the invention is. The following table is used to assign a first individual score based on number of patents and printed publications that are found in the field of the invention. Field of invention is a term used by patent attorneys and others in the patent field.

TABLE 1

| Number of prior art pieces in field of the invention | Score |
|---|---|
| 0-10 | 30 |
| 11-25 | 20 |
| 26-40 | 10 |
| 41-55 | 5 |
| 56 plus | 1 |

A second individual score may be based on a comparison to the best or closest piece of prior art. One preliminary aspect of applying a mathematical model is identifying the closest piece of prior art. This may be determined by any suitable means, including having a patent professional and/or a scientific expert identify it, using key terms to determine which reference is the closest based on the use and frequency of certain key terms to the invention idea, and other suitable identification means. Once the closest piece of art is identified, it should be compared to the invention. If the invention has 3 or more elements that are not disclosed in the closest piece of art, it should be assigned a 30 point individual score. If the invention idea has 2 elements that are not disclosed in the closest piece of art, it should be assigned a 20 point individual score. If the invention idea has 1 element that is not disclosed in the closest piece of art, it should be assigned a 10 point individual score. If the invention idea has all elements that are disclosed in the closest piece of art, it should be assigned a 0 point individual score.

Another individual score may be based on the field or use of the invention idea. Certain inventions in certain fields are more patentably desirable or more marketable than others. For example the following individual scores in Table 2 may be assigned to the following fields of inventions.

TABLE 2

| Field/Use of the Invention | Score |
|---|---|
| Medical use, device; pharmaceutical | 10 |
| Computer or electronic device; computer software or component | 10 |
| Home use/Consumer product | 5 |
| Agricultural product, device, method | 5 |
| Business method | 5 |
| Automotive/engine/equipment | 5 |
| Food/non-pharmaceutical chemicals/general chemicals | 5 |

Another individual score may be based on the number of potential users of the invention idea. This is a value that is more illustrative of the invention idea's potential marketability, not necessarily its patentability. For example, for a medical device that is specific to a particular surgery, its potential users are limited to the number of candidates annually for that particular surgery, not considering any market competitors. While, a consumer product, such as a toilet paper dispenser, may be used in every household and business, and in fact in multiple places in every household and every business. For example, the following individual scores seen in Table 3 may be assigned to an invention based on the potential users or uses, without considering competition.

TABLE 3

| Potential Uses of Invention | |
|---|---|
| (not accounting for competition) | Score |
| Over 50,000,000 | 30 |
| 10,000,001-50,000,000 | 20 |
| 5,000,001-10,000,000 | 10 |
| 2,000,001-5,000,000 | 5 |
| 1,000,000-2,000,000 | 1 |
| 999,999 or less | 0 |

Another individual score may take into account the inventor's own initial assessment of her invention idea. If an inventor self-describes her invention idea as being only a minor improvement to an existing device or product, that may be an indication that it is obvious and not patentable. If such a situation exists, a negative individual score, such as about minus 10 points may be assigned.

Another individual score related to marketing potential may take into account potential revenue to be generated from the sale or license of a product or process covered by the patent application. Another individual score may take into account the projected revenue to be generated from licensing the invention idea or the intellectual property protection covering the invention idea. This mean that license fees may be generated based on the patents and patent applications themselves, which usually are based on the projected revenue to be generated from the end product or process embodied by the patent and patent applications. For example, if it is projected that it will cost $1 to make the product, but it can be sold for $10, a $9 per product profit may be gained. Based on the potential users from Table 3, a projected profit may be calculated, without factoring in competition. Market research to determine an appropriate price point may also be advantageous. Building a prototype may be necessary to determine cost of manufacturing an individual product unit.

Additionally, a projected royalty may be calculated under a typical licensing agreement. If the product sells for $10, and a royalty rate of 10% is assumed, a $1 per product profit from royalties may be projected. Some industries may have typical royalty rates or ranges. For example, in the medical device field, royalty rates of about 25% may be typical, while in the financial services industry, because of the high volume of transactions, lower royalty rates, such as for example, 1-2% may be more typical. Again, the field of invention may be used to determine the typical royalty rate.

Another individual score may take into account the projected revenue to be generated from enforcing the intellectual property protection covering the invention idea, such as through patent litigation. Damages that may be awarded in a patent litigation are based on a reasonable royalty and/or lost profits. Both royalty rates and potential profits are discussed above.

Table 4 shows how an individual score may be generated based on the per unit (product or process) profit to be made without consideration of competition.

TABLE 4

| Profit per individual unit | |
|---|---|
| (without considering competition) | Score |
| Over $20 | 30 |
| $15-$19.99 | 20 |
| $10-$14.99 | 10 |
| $5-$9.99 | 5 |
| Under $5 | 0 |

If all individual scores detailed above are to be used in the model, they may be scaled such that the highest score the invention idea may receive is 100. A mathematical model may be created such that certain individual scores are weighed more heavily than others. For example, profit per individual unit may have a scaling of 4, indicating its relative importance, while field of the invention is given a scaling of ¼, indicating its relative lower importance to the overall aggregated score. Other scaling factors may be used.

The example of the mathematical model above contemplates that at least a prior art search is performed. Several of the individual scores are associated with the prior art search, such as the number of patents and publications in the field of the invention idea, and the comparison to the closest piece of prior art. Once the prior art search is conducted, the mathematical model will be used to generate an aggregate score and the bank may make an informed decision as to the risk associated with providing the loan. Other types of analysis, such as market research on the invention, building a model of the invention, and researching the invention's competition, may be worked into the existing mathematical model or be the basis of additional mathematical models. For example, some type of market analysis may be performed to identify the number of potential users of the invention, as described in Table 3.

Another example of an individual score that may be factored into a mathematical model is the number of competitors already existing in the marketplace and/or market share. An analyst may review the application and then research the number of competitors in the field of the invention. For example, an analyst would know that if the invention is one of a surgical screw, that there are several companies in the United States that manufacture and sell surgical screws. This list could be compiled. The greater the number of companies, the lower the individual score. This process may be fully or partially automated. For example, the words of invention idea disclosure may be converted into the key search terms for a competitor search. Any suitable intelligence, such as optical character recognition, word frequency and word count intelligence, and other technology, may be used to data mine the invention idea disclosure and find the key words to use for a competitor search to be performed on the internet or suitable database.

Suitable databases may be used or created by the financial institution to determine the competitors in a particular invention field. For example, there are several known companies in the medical device field. These companies would have products in both surgical screws and in artificial limbs, as well as other products.

Market share may be assumed to be pro-rata, based on the number of competitors. Alternatively, specific industries may have different market share statistics. If the borrower's invention idea is not in a traditional category that already has existing competitors, then the borrower's market share may be deemed to be 100%. Market share may thus be another individual score in the mathematical model.

Once these individual scores are calculated, the aggregated score, 1-100, is compared against the following Table 5 to determine the risk level for the lender.

TABLE 5

| Ranking Risk Level of Total Score | Total Score |
|---|---|
| Low Risk | 80-100 |
| Moderate Risk | 60-79 |
| High Risk | Less than 60 |

Thus, a financial institution may choose not to offer the loan to an individual unless the total score is greater than about 60, or some other suitable value. The present invention therefore takes, as data input, detailed information about the invention idea and converts the data into a form from which the financial institution can make an informed investment decision. In this way, the present invention uses mathematical modeling to transform information provided by the borrower into a physical loan product, embodying a decision made as to whether to extend a loan to the borrower, and the terms of the loan, the amount of the loan, and the money itself.

Another embodiment of the invention is a software application or computer input system wherein a loan application is received and processed according to the methods of the present invention. Types of data that should be inputted into the loan application include: the field of the invention idea, the title of the invention idea, the main components of the invention idea, what the inventor believes is the closest prior art, why the inventor believes the invention idea is useful, what improvements the inventor has made, the state of development of the invention idea to date, whether and under what circumstances has the inventor has disclosed the invention idea to others, whether and under what circumstances has the inventor publicly disclosed the invention idea, is the invention idea mainly directed to a device or method, if it is directed mainly to a method, is the method a new use for an old product, whether and under what circumstances did the inventor receive assistance from someone else, and what is the earliest date of the invention idea.

All of these pieces of data may be input into a computer software application via suitable input means, such as drop-down menu selection, into a spreadsheet, via an internet based application, via raw data input, and the like. Other data input may include traditional information used in a loan application, such as name, address, social security number, and the like.

For example, for an invention idea relating to a using aspirin to treat heart disease, the following information would be entered into a suitable software application. First, the inventor information, such as name, address and social security number would be entered. Next the title would be entered, “Methods and Use of Aspirin in the Treatment and Prevention of Heart Disease and Heart Conditions.” The field of the invention is “Treatment of the Heart”, or more generally, “Medical.” The “Field of Invention” individual score discussed above may be received directly from the loan application. The Fields of Invention listed in Table 2 above may be incorporated into any suitable selection menu in the application input form.

The main components of the invention idea would include: “identifying a patient with heart disease or heart conditions and administering aspirin to the patient.” The closest prior art would be entered and includes “using aspirin to treat headaches.” Why the invention idea is useful would be entered: “treats many common conditions associated with the heart.” The improvements would be entered next: “uses a well known and medically acceptable chemical that was used to treat headaches to treat heart conditions.”

Next, continuing with the present example, a loan processor would enter the state of the development as, “Inventor has not tested or experimented to date.” Other examples of standard responses may include: “some experimental testing”; “prototype built by inventor himself”; “prototype built by professional”; “drawings made, but no prototype”; and other suitable responses. Next, the loan processor would enter, “I have disclosed this to my spouse, but no others.” Other standard responses may include: “I have disclosed this to only very close friends or relatives”; “I have disclosed this to a work colleague”; and other suitable responses.

Next, the application would ask if the inventor has made a public disclosure of the invention idea, such as at a trade show, or in a speech or in a publication. This information could be put into suitable drop down selections with an explanation. If yes, then more information would need to be gathered, such as the date of any disclosure. If the information entered indicate that the inventor made a public disclosure over 1 year prior to the filing of the loan application, then the software should signal for a review of the information by a patent professional and the loan should only be issued if these issues are cleared. Of course, a public disclosure or dissemination of the invention idea may constitute a Section 102(b) bar to patentability if the disclosure or dissemination was over 1 year before the filing of the patent application.

Other information would be gathered by the software application from the inventor including his place of employment and the type of job he performs. Also, there should be questions about whether he thought of the invention idea on company time or using company equipment. If the answers indicated that the invention idea might be related to the inventor's employment with the company, then the software should signal for a review of the information by a patent professional and the loan should only be issued if these issues are cleared.

Other information to be gathered by the software application includes the circumstances of invention idea, such as when was the first “light bulb” or “eureka” moment. Other questions may include, “where were you at the time of the invention;” “what were you doing?”

Other information may be gathered to determine if there are single or multiple inventors. For example, the application may have a section for the names of the inventions. If the user of the application enters more than 1 name, the program will request further information. For example, “what did Inventor X contribute to the invention”; “what did Inventor Y contribute,” etc. The application may ask how the inventors worked on the invention, ask for a brief narrative and provide an example of a narrative. This is another section that may be reviewed by a patent professional if there are multiple inventors listed by the application to determine if there are in fact, multiple inventors.

The information to be entered into the software application may be data entered by a financial institutional professional while or after interviewing the inventor. The information may also be placed into a web-based application such that the inventor may fill in the information himself and apply for the loan over the internet. If the inventor is supplying the information himself, there may be many drop down selections to choose from to make the process user friendly. For the information that is not a menu selection, such as the Title and description of the Invention, an example may be provided, such as one for a method and one for a device so that the inventor understands the level of detail that is required to be entered. Thus, it is contemplated that a fully automated on-line loan input application may be developed such that a potential borrower may input the information necessary to evaluate the invention and the associated loan.

The input application may thus be linked directly to the mathematical model. Several pieces of information input may be placed into the model and individual scores may be generated. For example, the field of invention individual score may be generated by the information gathered in the application.

Once the following pieces of data are placed in the application, these pieces of data may be used to run a prior art search: field of the invention, the title of the invention, the main components of the invention, what the inventor believes is the closest prior art, why the inventor believes the invention is useful, and what improvements the inventor has made. This process may be fully automated. For example, the words of those responses may be turned into the key search terms for a prior art search. Any suitable intelligence, such as optical character recognition, word frequency and word count intelligence, and other technology, may be used to data mine the application and find the key words to use for a prior art search. For example, a word frequency or word count program may be run across the data inputted to identify these key terms, since they are likely to be the most frequently used words in this section of the loan application. Continuing with the above example of “aspirin used to treat heart conditions,” the following key words would be pulled from the loan application to perform the prior art search: Aspirin, treat, prevent, heart disease, heart condition, and headache. Other artificial intelligence means are suitable.

Once the key search terms are identified from the loan application, one or more relevant databases may be searched, such as for example the USPTO database, EPO database, WIPO database, Japan and Germany Abstracts, Derwent, and non-patent literature databases including IBM TDM, IP.com, Google & Google Scholar, STN, Dialog, IEE, Engineering Village, as well as other suitable patent and non-patent databases.

Similarly, other information from the loan application may be data-mined to perform market analysis. For example, a survey and/or questionnaire may be generated by the software application about the products or services embodied in the invention idea, directly from data provided as input into the software application. As described herein, this survey and questionnaire may be provided to third parties such as the financial institution's own customers to facilitate the market analysis.

A suitable system for facilitating the extension of a loan based on an invention idea according to the present invention may include computer readable programs embodied on at least one module in a computer hardware environment and configured to perform the steps set forth in FIG. 1 and described herein. Such a system may include, according to one embodiment, a computer implemented application connected to a spreadsheet application, the computer implemented application having a plurality of data input screens configured and arranged for input of financial data including loan origination data and data relating to one or more inventions, the computer application including information screens for displaying the results of an evaluation of the invention, wherein the evaluation is based on one or more of a prior art search on the invention, market research on the invention, building a model of the invention, and researching the invention's competition, and the computer application comprising means for comparing the evaluation to pre-selected risk criteria.

Other components of the system may include means for evaluating the invention, means for generating an approval of the borrower's ability to repay the loan based upon the evaluation, means for generating loan documentation based upon the evaluation, means for transmitting the loan documentation to the borrower, and means for generating a credit score.

Once the invention idea details are input into the application, the mathematical model is used to evaluate the potential of the invention. The financial institution may perform a prior art search on the invention, market research on the invention, building a model of the invention, and researching the invention's competition. The financial institution may perform one or more of these steps itself, or outsource these tasks to one or more providers. Examples of vendors include law firms, patent services companies, legal services companies, marketing firms, consulting services companies, financial consulting firms, and other similar companies. These companies may be domestic or foreign. Specifically, it is contemplated that a foreign patent services company located in China, Japan, Korea, India, or any other country, may perform a prior art search. One aspect of the mathematical model may also therefore be an analysis of whether the invention idea is appropriate for disclosure to a foreign service provider, or whether a recommendation should be made to a patent professional to evaluate the need for approval prior to such disclosure to avoid violating one or more export control laws in the United States.

Market research regarding the invention idea may be performed by the financial institution extending the loan, or by a third party such as a market research firm. The financial institution may use its existing customer base to participate in the market research, such as for example research relating to consumer preferences and needs. As incentives for the customers to participate in the market research surveys and/or questionnaires, customers may be offered more favorable terms on the financial institution's products and/or services. For example, if a customer completes two surveys per year, that customer may receive an extra percentage point for an existing interest checking account. Other incentives for survey participation include more favorable rates and/or terms on additional checking accounts, savings accounts, loan rates, mortgage rates, and any other financial institution product. Such surveys and/or questionnaires may be automatically initiated by the software application discussed herein and conveyed to customers of the financial institution.

Once the loan is provided, the financial institution may attempt to procure intellectual property protection for the invention idea in one or more jurisdictions. This may include drafting and filing one or more patent applications in one or more national patent offices, including patent applications in the United States, under the Patent Cooperation Treaty, the European Patent Office, and any other country. The loan agreement between the borrower and the financial institution may detail who is to handle and prosecute the patent applications, and the associated fees and expenses. Most likely, the financial institution will handle these matters on behalf of the inventor. As with the analysis discussed over, the financial institution may perform one or more of drafting, filing, and prosecuting of the patent applications itself, or outsource these tasks to one or more providers. The present invention contemplates that both utility and design patent applications, and provisional and non-provisional patent applications, may be included in the intellectual property protection sought. The intellectual property protection sought may further include trademark and service mark protection in the United States, under the Madrid Protocol, or any other jurisdiction.

Alternatively, the financial institution may not draft and file a patent application. In that case, the loan amount may be used by the borrower for that purpose. In any event, the loan may be conditioned on its use going toward the invention development, or not, like in a home equity line of credit.

The borrower's credit score may also be factored into the evaluation of the terms of the loan agreement. For example, the credit score may be a factor in determining the interest rate on the loan.

The present invention also contemplates a way to mathematically determine the terms of the loan agreement based on the results of the analysis on the invention idea. Factors that depend on the analysis include: (1) whether the financial institution will own a percentage of the invention or take a security interest in the invention; (2) the percentage of the ownership interest, if any; (3) the loan amount, (4) the loan rate; and (5) the repayment terms, such as total duration. Financial institutions may also alter and adjust the terms of the loan based on other competitive factors.

For example, if an invention idea gets a total score of at least 60 (moderate or low risk), and the inventor has average or above average credit, he may be able to receive a loan for $50,000 at 5% over 10 years, with the financial institution owning 10% ownership interest in the invention. Other scenarios and more detailed models are possible and may be developed accordingly. Of course, market forces may also drive the loan terms.

The present invention therefore converts the results of the market analysis of the invention idea into data from which the financial institution can make a further informed investment decision and extend customized terms to a borrower. Mathematical modeling is therefore used to transform information generated from a detailed analysis of the invention idea provided by the borrower into specific terms of a physical loan product.

The success of invention idea may factor into whether the financial institution will forgive some of the repayment of the loan. This forgiveness may be detailed in any supporting loan documentation. For example, if the financial institution recoups the amount of the loan via its ownership in the invention in half of the time of the repayment of the loan, then the loan is forgiven. Also, if bank receives royalties from the invention, the initial loan and its monthly payments may be forgiven at the discretion of the lending institution. Other examples may be negotiated or provided.

Since the financial institution will be effectively taking an ownership and/or security interest in the invention idea, the potential borrower should be advised that he should obtain separate legal counsel in his negotiation with the financial institution.

While it may appear that the borrower is not benefiting from the contemplated arrangement, the borrower does receive funding that may not otherwise be available to him, based on traditional loan factors, such as credit. Additionally, the borrower may have a financial institution handling the fees, expenses, and obligations of filing and obtaining patent protection for his invention. Finally, since the financial institution has an ownership interest in the invention idea, it is financially motivated to develop, market, license, and sell the invention, tasks that an inventor may not have been able to do on his own.

The present invention contemplates that invention ideas forming the basis of a loan to be extended to a borrower may be in varying states of development. While borrower's may be more inclined to seek loans for invention ideas for which no intellectual property protection has been filed or for which no product development has occurred, it is possible that borrowers may approach financial institutions for loans where one or more applications for intellectual property protection have already been filed or obtained. Therefore, the present invention contemplates that multiple objectives may be achieved through loans extended and secured by invention ideas, including developing products covered by the invention idea, filing for intellectual property protection, or some combination. Uses for loans extended according to the present invention are therefore not intended to limited to any one objective, and are to be understood to be used according to the specific needs of a particular borrower.

The present invention further contemplates that loans extended according to the present invention may be used for purposes completely unrelated to the developing of a product or acquiring intellectual property. For example, an invention idea may be used as collateral for a loan to purchase real or commercial property.

The present invention further contemplates that the financial institution may file one or more trademark applications in the United States, under the Madrid Protocol, or in any other national trademark office to cover products and services embodied in the borrower's invention idea. The data provided for the loan application may solicit information from the borrower regarding specific names for the invention that may themselves be evaluated for possible protection under trademark laws as trademarks or service marks. Such names may be used in commerce to develop branding or market recognition of products covering the invention idea, and may acquire significant value in the marketplace, providing further support for a determination that a loan should be extended to the borrower.

It is to be understood that other embodiments may be utilized and structural and functional changes may be made without departing from the scope of the present invention. The foregoing descriptions of embodiments of the invention have been presented for the purposes of illustration and description. It is not intended to be exhaustive or to limit the invention to the precise forms disclosed. Accordingly, many modifications and variations are possible in light of the above teachings. For example, the financial institution may solicit the help of existing customers to conduct market research for an invention, and may offer financial incentives for doing so.

Additionally, a third party may perform all the steps of FIG. 1 and identify an appropriate financial institution and make a recommendation thereto to extend a loan to a borrower with an invention idea. It is therefore intended that the scope of the invention be limited not by this detailed description.

1. A method of securing a loan to be extended to a borrower, comprising:
evaluating an invention idea invented by a borrower, the evaluating an invention idea comprising determining a market potential for the invention idea and analyzing a likelihood of obtaining intellectual property protection covering the invention idea in at least one jurisdiction;
assigning at least one value to the invention idea at least partially based on evaluating the invention idea,
determining one or more terms of a loan to be extended to the borrower; and
obtaining, from the borrower, one or more of an ownership interest in the invention idea or a security interest in the invention idea as collateral for the loan.

2. The method of claim 1, wherein the one or more terms of a loan include an amount of money.

3. The method of claim 2, further comprising loaning the amount of money to the borrower.

4. The method of claim 1, wherein the ownership interest is an assignment of at least partial rights to intellectual property protection covering the invention idea.

5. The method of claim 1, wherein the determining a market potential for the invention idea further comprises at least one of projecting revenue to be generated from licensing the invention idea, projecting revenue to be generated from licensing intellectual property protection covering the invention idea, and projecting revenue to be generated from enforcing the intellectual property protection covering the invention idea.

6. The method of claim 1, wherein the evaluating an invention idea invented by a borrower further comprises determining the borrower's credit score.

7. The method of claim 1, further comprising requiring a fee to be paid by the borrower for performing the evaluation of the invention idea.

8. The method of claim 1, further comprising conducting a prior art search to evaluate patentability of the invention idea.

9. The method of claim 1, further comprising procuring intellectual property protection for the invention idea in at least one jurisdiction.

10. The method of claim 1, further comprising the financial institution relieving repayment of at least some of the loan if certain pre-selected conditions relating to the financial success of the invention are satisfied.

11. The method of claim 2, wherein the amount of money loaned to the borrower is at least partially used by the borrower to develop the invention idea.

12. The method of of claim 2, wherein the amount of money loaned to the borrower is at least partially used by the borrower to purchase real property.

13. The method of claim 1, wherein the determining a market potential for the invention idea further comprises soliciting survey information about the invention idea from customers of the financial institution.

14. A method of extending a loan to a borrower, comprising:
soliciting a description of an invention idea from the borrower;
conducting an analysis of the invention idea, the analysis including an identification of an invention field, a study of market potential for at least one product covered by the invention idea, and a patentability study of the invention idea in at least one jurisdiction;
determining one or more terms of a loan to be extended to the borrower based at least in part upon converting a result of the analysis of the invention idea into at least one value of the invention idea;
securing the invention idea as collateral for the loan; extending the loan to the borrower.

15. The method of claim 14, wherein the one or more terms of a loan include an amount of money.

16. The method of claim 14, further comprising closing the loan.

17. The method of claim 14, further comprising making a recommendation to a financial institution on the one or more terms of the loan based at least in part on the result of the analysis.

18. The method of claim 14, wherein the financial institution is a bank.

19. The method of claim 14, wherein the financial institution is a venture capital firm.

20. The method claim 14, wherein the loan is extended at least in part to bring at least one product covered by the invention idea to market.

21. The method of claim 14, wherein the loan is extended at least in part to fund a purchase of property.

22. The method of claim 14, further comprising assigning a risk factor to the invention idea, wherein the value of the invention idea and the one or more terms of the loan to be extended to the borrower are modulated by the risk factor to arrive at a modified value of the invention idea.

23. The method of claim 14, wherein the securing the invention idea as collateral comprises obtaining a security interest in the invention idea.

24. The method of claim 14, wherein the securing the invention idea as collateral comprises obtaining an ownership interest in the invention idea, wherein the ownership interest is an assignment of at least partial rights to intellectual property protection covering the invention idea.

25. The method of claim 14, wherein the patentability study of the invention idea in at least one jursidiction further comprises conducting a prior art search to evaluate patentability of the invention idea.

26. The method of claim 14, further comprising performing services related to procuring intellectual property protection, including filing at least one patent application and prosecuting the at least one patent application.

27. The method of claim 26, wherein the performing services related to procuring intellectual property protection further comprises filing at least one trademark application and prosecuting the at least one trademark application.

28. The method of claim 14, wherein the soliciting a description of an invention idea from the borrower further comprises executing a confidentiality agreement with the borrower.

29. The method of claim 14, wherein the conducting an analysis of the invention idea further comprises at least one of building a model of a product covering the invention idea, researching potential competition for a product covering the invention idea, and comparing results of the anlaysis to pre-selected criteria.

30. The method of claim 29, wherein the pre-selected criteria comprise one or more of a baseline determination of profitability, a baseline determination of percentage market share, a baseline determination of cost for making the invention, a numerical value based on the numbers of patents in the field of the invention, a numerical value ranking the invention to the closest piece of prior art, and number of competitors.

31. The method of claim 30, wherein the determining one or more terms of a loan to be extended to the borrower based at least in part upon converting a result of the analysis of the invention idea into a value of the invention idea further comprises assigning a first value based on a number of patents and printed publications in an invention field, identifying a closest piece of prior art, comparing the invention idea to the closest piece of prior art, assigning a second value based on a number of elements lacking in the closest piece of prior art when compared to the invention idea, and summing the first value and the second value together to generate a score.

32. The method of claim 31, further comprising identifying a number of potential users of the invention and assigning a third value based on the number of potential users.

33. A system for facilitating the extension of a loan based on an invention idea comprising:
a computer readable program, embodied on at least one module in a computer hardware environment, configured to accept a description of an invention idea from a borrower;
a computer readable program, embodied on at least one module in a computer hardware environment, configured to conduct an analysis of the invention idea, the analysis including an identification of an invention field, a study of market potential for at least one product covered by the invention idea, and a patentability study of the invention idea in at least one jurisdiction;
a computer readable program, embodied on at least one module in a computer hardware environment, configured to convert a result of the analysis of the invention idea into a value of the invention idea, the value of the invention idea determined by comparing a result of the analysis to pre-selected criteria that comprise one or more of a baseline determination of profitability, a baseline determination of percentage market share, a baseline determination of cost for making the invention, a numerical value based on the numbers of patents in the field of the invention, a numerical value ranking the invention to the closest piece of prior art, and number of competitors, wherein the program assigns a first value based on a number of patents and printed publications in an invention field, identification of a closest piece of prior art, and a comparison of the invention idea to the closest piece of prior art, and assigns a second value based on a number of elements lacking in the closest piece of prior art when compared to the invention idea, and sums the first value and the second value together to generate a score; and
a computer readable program, embodied on at least one module in a computer hardware environment, configured to determine one or more terms of a loan to be extended to the borrower based upon the value of the invention idea.

34. The system of claim 33, further comprising one or more of a computer readable program, embodied on at least one module in a computer hardware environment, configured to generate an approval of the borrower's ability to repay the loan based upon the analysis of the invention idea, a computer readable program configured to generate loan documentation based upon the analysis of the invention idea, a computer readable program configured to transmit the loan documentation to the borrower, and a computer readable program configured to a generate a credit score of the borrower.

35. The system of claim 34, wherein the value of the invention idea is further determined by identifying a number of potential users of the invention, the computer readeable program configured to convert a result of the analysis of the invention idea into a value of the invention idea further configured to assign a third value based on the number of potential users and a fourth value to the invention field.

36. The system of claim 33, further comprising a computer readable program, embodied on at least one module in a computer hardware environment, configured to identify an appropriate financial institution and convey a recommendation to the financial institution on the loan application.

37. The system of claim 33, further comprising a computer readable program, embodied on at least one module in a computer hardware environment, configured to generate documentation to obtain one or more of an ownership interest in the invention idea or a security interest in the invention idea as collateral for a loan.

38. The system of claim 33, further comprising a computer readable program, embodied on at least one module in a computer hardware environment, configured to initiate a survey to solicit information about the invention idea from customers of a financial institution.
